(19) United States
(12) Patent Application Publication
(10) Pub. No.: US 2008/0237458 A1
(43) Pub. Date: Oct. 2, 2008

(54) AUTOMATED MASS SPECTRAL IDENTIFICATION

(76) Inventor: Yongdong Wang, Wilton, CT (US)

Correspondence Address: David Aker, 23 Southern Road, Hartsdale, NY, 10530, US

(21) Appl. No.: 12/061,595

(22) Filed: Apr. 2, 2008

Related U.S. Application Data
(60) Provisional application No. 60/909,702, filed on Apr. 2, 2007.

(51) Int. Cl. B01D 59/44; G06F 19/00

(52) U.S. Cl. 250/282; 702/23; 250/287

(57) ABSTRACT

An automated or fully automated mass spectral system and a method of operating the system to identify a sample ion or compound. The system includes at least one computer addressable holder for at least one of standard and sample; at least one mass spectrometer configured to acquire one of continuum, profile, and raw mode mass spectral data; a computer system including a first software component to control introduction of at least one of the sample and the standard, data acquisition, and data analysis; a second software component for performing a mass spectral calibration involving at least m/z value, to report at least one of accurate mass, a list of possible elemental compositions, and a measurement statistic; and a third software component capable of acting on reported result or measurement statistic to change at least one of the introduction of at least one of the sample and the standard, data acquisition, data analysis, reported result, and measurement statistic. A computer readable medium having computer readable program code therein for use in the method or system.

This application claims priority under 35 U.S.C. § 119(e) from provisional application Ser. No. 60/909,702 filed on Apr. 2, 2007, which is incorporated herein, in its entirety.

### BACKGROUND OF THE INVENTION

1. Field of the Invention

The present invention relates to the identification of compounds with the use of a mass spectrometer, advanced computer control, data acquisition, and data processing, all in an unattended and automated fashion. More particularly, it relates to those apparatus and methods that may be used to identify compounds with a high degree of confidence in the absence of human intervention.

2. Prior Art

High confidence compound identification typically involves the use of a high resolution mass spectrometer (MS) capable of 10,000 or higher resolving power, such as available on a Time-Of-Flight (TOF) MS, e.g., manufactured by Agilent Technologies Inc. in Santa Clara, Calif., OrbiTrap MS, e.g., manufactured by Thermo Electron Corp. in Waltham, Mass., and ICR FT MS, e.g., manufactured by Bruker Daltonics in Germany. On these systems, a high degree of mass accuracy can be achieved, with mass errors typically less than 5 ppm and approaching 100 ppb, allowing for nearly unique compound identification including formula determination. Unfortunately, these systems are large, bulky, and require a significantly higher cost to end users than simpler systems. Further, they are much harder to operate, due to issues such as limited dynamic range in TOF and space charges in OrbiTrap or FT MS systems.

On the other hand, much simpler and affordable, robust, and very easy-to-operate mass spectrometers, such as single quadrupole MS, are believed to be of only unit mass resolution and incapable of achieving high enough mass accuracy for compound identification, including formula determination. With the comprehensive mass spectral calibration approach disclosed in U.S. Pat. No. 6,983,213, of the present inventor, assigned to the present assignee, and incorporated herein by reference in its entirety, it has been shown that high mass accuracy approaching 5 ppm can be obtained on a unit mass resolution quadrupole system as well (Gu et al, Rapid Commun. Mass. Spectrom. 2006; 20:764). This level of performance, however, requires careful experimentation when it comes to calibration standards, their relative m/z locations, their signal to noise from the profile mode MS measurement, and time-dependent m/z shift between the time of calibration and the time of unknown measurement in the case of external calibration. Other factors, including the concentration of the unknown and the signal to noise in the profile mode MS measurement, the mass spectral scan rate, sample introduction rate, mass spectral scan range, and mass spectral scan mode (full scan vs Selected Ion Monitoring or SIM) also play a role in the mass accuracy level that may be achievable.

### SUMMARY OF THE INVENTION

It is an object of this invention to provide a fully automated analysis system for high confidence compound identification by automatically setting up the experiment and adjusting the necessary parameters so that reliable compound identification results can always be guaranteed.

It is another object of the invention to provide apparatus and methods having an advantage even over existing high complexity, high resolution systems in terms of un-attended MS operation.

It is another object of the invention to provide the necessary measurement statistic for proper real time feedback to the analysis system and to allow for measurement refinement on-the-fly until an acceptable level of performance has been achieved.

It is another object of the invention to provide an easy means for lower end quadrupole MS systems to achieve high enough mass accuracy measurement for compound identification including formula determination.

It is yet another object of the invention to provide an automatic means for introducing the necessary standards automatically, in real time for high mass accuracy measurement.

These objects and others are achieved in accordance with the invention by the use of at least one sample or standard that can be automatically presented to the mass spectrometer for analysis through computer control. Based on the approximate masses of the sample and the standard, mass spectral experimental and data acquisition parameters such as mass scan range, scan rate, sample introduction flow rate, etc. can be automatically selected prior to the actual data acquisition. An initial compound identification is performed using a highly accurate mass spectral calibration with key statistical measures calculated to judge the goodness or accuracy of this initial identification. The statistical measures thus obtained are used to decide if further refinement of the compound identification may be required and what changes need to be made concerning the standard mass(es) and other experimental and data acquisition parameters. The process may be repeated a few times until the statistical measure meets a certain preset criterion, at which point a summary report may be generated for the compound identification.

Thus, the invention is directed to an automated or fully automated, mass spectral system and a method of operating the system to identify a sample ion or compound. The system includes at least one computer addressable holder for at least one of a standard and a sample; at least one mass spectrometer configured to acquire one of continuum, profile, and raw mode mass spectral data; a computer system including a first software component to control introduction of at least one of the sample and the standard, data acquisition, and data analysis; a second software component for performing a mass spectral calibration involving at least m/z value, to report at least one of accurate mass, a list of possible elemental compositions, and a measurement statistic; and a third software component capable of acting on reported result or measurement statistic to change at least one of the introduction of at least one of the sample and the standard, data acquisition, data analysis, reported result, and measurement statistic.

The invention is also directed to a computer readable medium having computer readable program code therein for implementing the method or the system.

### BRIEF DESCRIPTION OF THE DRAWINGS

The foregoing aspects and other features of the present invention are explained in the following description, taken in connection with the accompanying drawings, wherein:

FIG. 1 is a schematic of a typical MS system.

FIG. 2 shows two examples for auto sampler tray arrangements with multiple computer addressable sample holders.

FIG. 3 is a typical flowchart for a fully automated MS system for compound identification with high mass accuracy.

FIG. 4 contains one scheme for switching in the calibration standard (injecting sample with selected standard(s)).

FIG. 5 contains another scheme for switching in the calibration standard (infusing standard(s) with an autosampler).

FIG. 6 contains yet another scheme for switching in the calibration standard (multiple-port valve switching).

### DETAILED DESCRIPTION OF THE PREFERRED EMBODIMENTS

There are some commercially available components that can be used for sample and standard introduction, e.g., offerings from LEAP Technologies as indicated below:

Application Note: Sandwich technique for small sample volumes
LEAP Application Note
Revision: 1.0 Date: 06-21-2004 Author: Thomas Tobien
Objective/Abstract
The PAL autosampler injection syringe is utilized for analyte infusion during mass spectrometer tuning. Infusion occurs either into an LC mobile phase stream (Option A) or directly into the LC interface of a mass spectrometer (Option B). After installation of a large volume syringe, a local firmware method and job is created that controls analyte infusion.
LEAP Technologies Download
LEAP Application Note—PAL as syringe pump Click the Link Below to Access the Download
LEAP Application Note PAL as Syringe Pump rev01.pdf 31.7 KB mod. 2005-07-28.
Using the PAL Autosampler as a Syringe Pump for MS Tuning
LEAP Application Note
Revision: 1.0 Date: 06-21-2004 Author: Thomas Tobien
Objective/Abstract
The PAL autosampler injection syringe is utilized for analyte infusion during mass spectrometer tuning. Infusion occurs either into an LC mobile phase stream (Option A) or directly into the LC interface of a mass spectrometer (Option B). After installation of a large volume syringe, a local firmware method and job is created that controls analyte infusion.
LEAP Technologies Download
LEAP Application Note—PAL as syringe pump Click the Link Below to Access the Download
LEAP Application Note PAL as Syringe Pump rev01.pdf 31.7 KB mod. 2005-07-28

More and more applications of mass spectrometry for compound identifications now go beyond the traditional nominal mass confirmation and require accurate mass measurement of better than 5 ppm. The conventional wisdom for achieving such high mass accuracy is through the use of a high resolution systems such as qTOF. Higher resolving power leads to proportionally more accurate mass measurement, as given by the following relationship (Blom, K. R., Anal. Chem., 2001; 73: 715):

$$σ ∝ \frac{1}{R \sqrt{S}}$$

where σ is the mass measurement error expressed in ppm, R is the mass spectral resolving power (mass divided by the Full Spectral Width at Half Maximum height or FWHM at given mass), and S is the ion signal level assuming only ion counting noise—a reasonable assumption for a well designed mass spectrometer. With internal mass calibration, the mass accuracy of 10 mDa has been achieved on a high resolution quadrupole instrument (FWHM=0.1 Da) when operated on selected reaction monitoring mode, as reported by Grange, A. H. et al, Rapid Commun. Mass Spectrum., 2005; 19: 2699. This operational mode obviously resulted in high R value and partially contributed to the mass accuracy improvement. For an MS system operating at both low and high resolution modes, the resolving power at unit mass resolution (FWHM=0.5 Da) for a small molecule of 500 Da may be only 1,000 with a factor of 5 loss compared to a higher resolving power of 5,000. However, this loss of resolving power can be partially or fully compensated for by the higher ion signal available when operating at a lower resolution. It has been shown that achieving high mass accuracy of a few mDa or even 5 ppm can be attained on unit mass resolution systems in both infusion mode and on chromatographic time scale (Gu, M. et al, Proc. 53st ASMS Conf. Mass Spectrometry and Allied Topics, San Antonia, Jun. 5-9, 2005, Poster No. 050). The higher resolution and separation power available on qTOF systems, nonetheless, still holds an intrinsic advantage over unit mass resolution systems in the physical rejection of ions with masses close to those of the ions of interest.

On higher resolution systems such as qTOF, OrbiTrap, or FT ICR MS, the linear dynamic range is typically more limited than on a lower resolution quadrupole MS system, due either to detector saturation or space charges. It is in fact commonly encountered on a qTOF or TOF system where the signal of either the unknown or (internal) the standard (or both) easily saturates, leading to unreliable mass measurement results. A trained mass spectrometrist is often required to operate these high end instruments so as to inspect and repeat these experiments, if needed, resulting in significant productivity loss.

On lower resolution systems such as a single quadrupole MS, the linear dynamic range is much wider without the need to be concerned with space charge effects. As indicated in above equation, however, the signal to noise issue becomes more important on these systems. With enough signal to noise and a more comprehensive mass spectral calibration disclosed in U.S. Pat. No. 6,983,213, the same 5 ppm mass accuracy can be achieved, making use of the much more commonly available single or quadrupole instrumentation.

For both low resolution and high resolution systems, achieving high mass accuracy requires careful experimentation and skill, which the present invention minimizes or eliminates, by taking advantages of the sample introduction control, instrument control, and data acquisition control, all of which are readily available and automatable on commercial instruments. The invention also presents unique measurement statistics. The objective is to have a fully automated, walk-up or turn-key or open access MS system that can identify compounds with high mass accuracy in a fully automated fashion without human intervention during the measurement process, even on low end unit mass resolution systems.

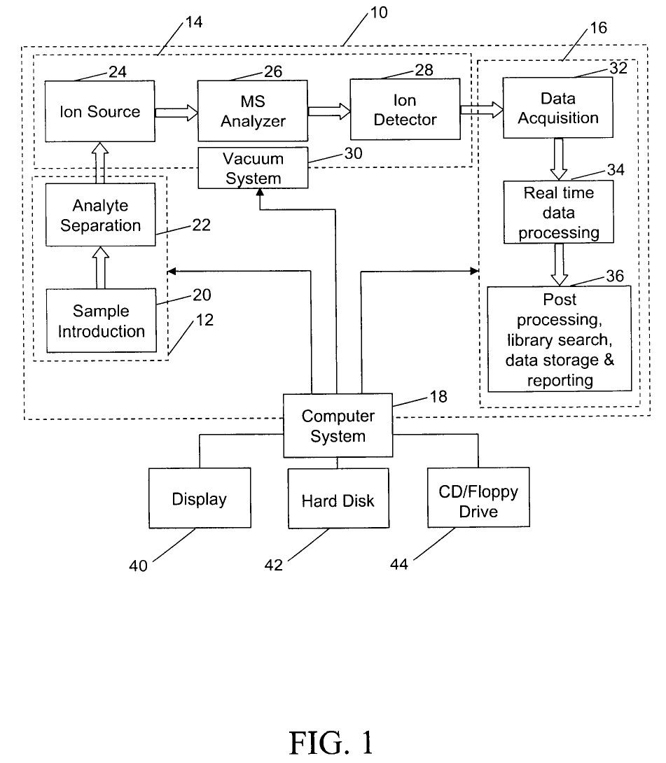

Referring to FIG. 1, there is shown a block diagram of an analysis system 10, that may be used to analyze proteins or other molecules, as noted above, incorporating features of the present invention. Although the present invention will be described with reference to the embodiments shown in the drawings, it should be understood that the present invention can be embodied in many alternate forms of embodiments. In addition, any suitable types of components could be used.

Analysis system 10 has a sample preparation portion 12, a mass spectrometer portion 14, a data analysis system 16, and a computer system 18. The sample preparation portion 12 may include a sample introduction unit 20, of the type that introduces a sample containing proteins or peptides of interest to system 10, such as Finnigan LCQ Deca XP Max, manufactured by Thermo Electron Corporation of Waltham, Mass., USA. The sample preparation portion 12 may also include an analyte separation unit 22, which is used to perform a preliminary separation of analytes, such as the proteins to be analyzed by system 10. Analyte separation unit 22 may be any one of a chromatography column, an electrophoresis separation unit, such as a gel-based separation unit manufactured by Bio-Rad Laboratories, Inc. of Hercules, Calif., and is well known in the art. In general, a voltage is applied to the unit to cause the proteins to be separated as a function of one or more variables, such as migration speed through a capillary tube, isoelectric focusing point (Hannesh, S. M., Electrophoresis 21, 1202-1209 (2000), or by mass (one dimensional separation)) or by more than one of these variables such as by isoelectric focusing and by mass (two dimensional separation). An example of the latter is known as SDS-PAGE.

The mass spectrometer portion 14 may be a conventional mass spectrometer and may be any one available, but is preferably one of MALDI-TOF, quadrupole MS, ion trap MS, qTOF, TOF/TOF, or FTICR-MS. If it has a MALDI or electrospray ionization ion source, such ion source may also provide for sample input to the mass spectrometer portion 14. In general, mass spectrometer portion 14 may include an ion source 24, a mass analyzer 26 for separating ions generated by ion source 24 by mass to charge ratio, an ion detector portion 28 for detecting the ions from mass analyzer 26, and a vacuum system 30 for maintaining a sufficient vacuum for mass spectrometer portion 14 to operate efficiently. If mass spectrometer portion 14 is an ion mobility spectrometer, generally no vacuum system is needed.

The data analysis system 16 includes a data acquisition portion 32, which may include one or a series of analog to digital converters (not shown) for converting signals from ion detector portion 28 into digital data. This digital data is provided to a real time data processing portion 34, which process the digital data through operations such as summing and/or averaging. A post processing portion 36 may be used to do additional processing of the data from real time data processing portion 34, including library searches, data storage and data reporting.

Computer system 18 provides control of sample preparation portion 12, mass spectrometer portion 14, and data analysis system 16, in the manner described below. Computer system 18 may have a conventional computer monitor 40 to allow for the entry of data on appropriate screen displays, and for the display of the results of the analyses performed. Computer system 18 may be based on any appropriate personal computer, operating for example with a Windows® or UNIX® operating system, or any other appropriate operating system. Computer system 18 will typically have a hard drive 42, on which the operating system and the program for performing the data analysis described below is stored. A drive 44 for accepting a CD or floppy disk is used to load the program in accordance with the invention on to computer system 18. The program for controlling sample preparation portion 12 and mass spectrometer portion 14 will typically be downloaded as firmware for these portions of system 10. Data analysis system 16 may be a program written to implement the processing steps discussed below, in any of several programming languages such as C++, JAVA or Visual Basic.

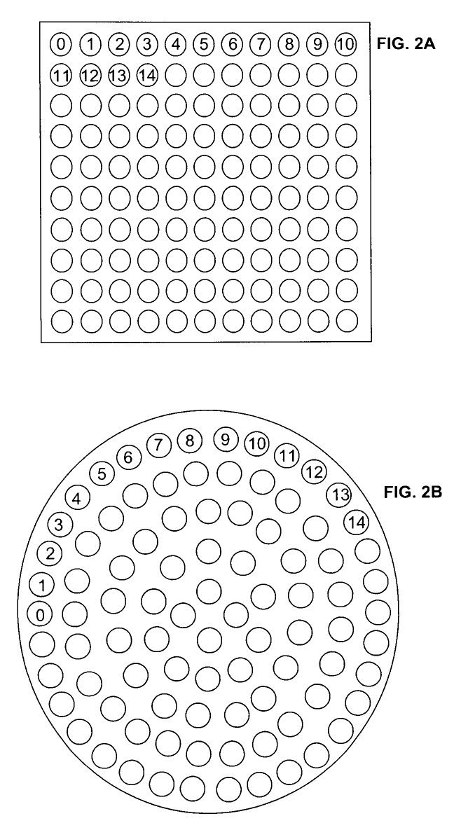

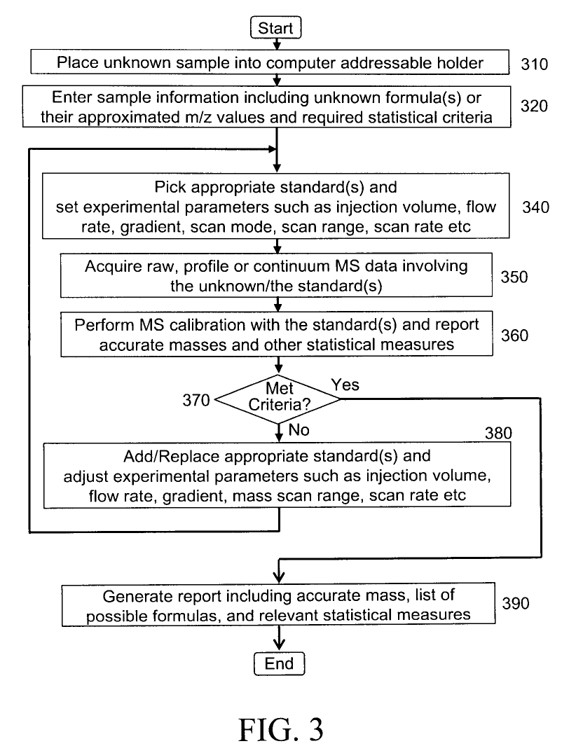

In sample wells numbered between 0 and 9 in FIG. 2, for example, up to ten standards can be placed. These ten standards may contain standard ions at m/z values between 200 to 650 Da with approximately 50 Da m/z spacing so as to cover the mass range for small molecule drug applications. Each may be either pure standards or mixtures of standards. Note also that even a pure standard may be capable of generating a series of ions across a mass range to serve as mass spectral calibration standards, such as PFTBA commonly used and typically integrated with GC/MS instrument systems and under full computer control through a valve. For mixture standards, there may exist ion suppressions among different ions involved, depending on the type of ionization utilized. Some of these standard wells can also contain the same standard at different concentration levels. The standard ions associated with each well should be known exactly, e.g., with their elemental compositions stored in the computer or entered by the analyst prior to the start of experimentation depicted in FIG. 3.

Some of these standards may be treated as unknowns for time to time measurements, as part of the system-wide check to insure that the entire system is performing to the preset criteria before the next batch of unknown measurements, in which case the software controlling the entire system may indicate “Ready” for processing new samples. Otherwise, the system may indicate “System Service” so that system maintenance may be performed, e.g., the standards can be replaced with freshly prepared solutions etc.

Referring to step 310 in FIG. 3, a sample is placed into a given computer addressable holder. This sample may be a true unknown with just an estimated m/z value that needs to be accurately determined or a semi-unknown with a suspected formula such as the case in organic synthesis confirmation. It may also be a complete unknown where all major ions are to be determined with respect to their accurate masses and formulas.

In step 340, if the expected nominal mass is given for the sample, the system, under fully automated computer control, picks a standard well corresponding to a known calibration ion whose m/z value is closest to that of the sample. A set of proper mass spectral scan parameters is determined, for example, to scan from less than the minimum of the two m/z values to more than the maximum of the two m/z values, or to scan in the Selected Ion Monitoring (SIM) mode to cover just the m/z mass ranges of the two ions, and leaving the mass range between the two m/z values unmeasured, in order to maximize the signal to noise available for the standard and the sample ion.

If one does not know the m/z values of the sample and needs to have all ions or ions of a given mass range determined, the mass spectrometer is set to perform a full mass spectral scan in the given range and the computer comes up with a list of m/z values with significant ion signal intensities to be identified first, before returning to step 340 for a detailed analysis.

As an option, one may choose no standard to be measured along with the sample, if a prior mass spectral calibration has been established and deemed applicable to the sample ion to be measured. In this case, a SIM scan across just the unknown ion would be likely to provide the highest available signal to maximize the mass accuracy achievable.

Other experimental or scan parameters that could not be determined at the first iteration, such as injection volume, flow rate, scan rate, etc. would be left at default values before proceeding to steps 350 and 360 where the required mass spectral data are acquired and calibration is performed. At step 360, one may choose to have the standard measured first, as if it was an unknown sample, so as to check and see if a prior calibration is still valid and no new calibration may be required. As a result of this standard measurement, if a new calibration is indeed required, but only a limited new calibration is needed (e.g., just a simple mass shift term is required to compensate for the instrument drift), a much simpler update can be applied to a prior calibration to arrive at an extensive, but updated, mass spectral calibration. If a new extensive mass spectral calibration needs to be built from scratch, the necessary standards are selected and measured by looping through steps 340-380.

After the sample ion has been measured, which typically would be composed of multiple MS scans covering at least the monoisotopic peak, the applicable calibration can be applied to each scan of the sample ion to arrive at an accurate mass value. Statistical measures, e.g., the standard deviation, can be calculated from the multiple accurate mass values from the multiple MS scans acquired, as an indication of the measurement precision achieved. Other measures, e.g., the dependence of reported accurate mass on peak ion intensity, can be used as an indicator of signal saturation where the reported mass is typically associated with a negative bias. The mass difference between M+1 and M is also an important statistical measure, which typically should come very close to 1.00336 Da for carbon-containing organic compounds. Another important measure is to use the calibration mass spectrum to search for possible formula candidates and report a residual between the calibrated mass spectrum and its theoretically calculated version based on available natural abundances, as disclosed in U.S. Provisional patent applications 60/466,010; 60/466,011 and 60/466,012 all filed on Apr. 28, 2003, and International Patent Applications PCT/US2004/013096 and PCT/US2004/013097 both filed on Apr. 28, 2004 and both designating the United States of America as an elected state. This residual error can also be expressed as a new metric called Spectral Accuracy™ or SA, defined as

$$S A = ( 1 - \frac{{‖ e ‖}_{2}}{{‖ r ‖}_{2}} ) \times 100$$

where e is the fitting residual between the two vectorized spectra, r is the calibrated mass spectral vector, and ∥.∥₂ is the 2-norm of the corresponding vectors. While the present invention uses the 2-norm, any higher or lower order norm may also be used.

An SA can also be calculated for the standard(s) selected and measured, as a check of system readiness, standard contamination, or signal saturation.

A compromised SA and other statistical measures would indicate possible signal saturation, potential ion interference, lack of ion signal, or a need to update calibration or rebuild the calibration. If signal saturation is suspected, a smaller injection volume and/or faster flow rate may be selected for the next iteration. If ion interference is suspected, a more detailed GC or LC separation may be required during the next iteration where a different solvent gradient or temperature programming may be required. If a new calibration is needed, proper standard(s) are introduced during the next iteration to build an updated or full calibration. If the standard deviation reported for the accurate mass measurement is too high, a larger injection volume, shorter mass scan range, and slower flow rate may be required.

In the case of organic synthesis confirmation with required 5 ppm mass accuracy, one may start with the closest standard for calibration and measure the mass error and compare it to the standard deviation. If the standard deviation is significantly larger than the mass error, a larger sample volume or longer measurement time is required for the sample measurement in order to reduce the random fluctuation in the measurement reflected by the large standard deviation. If on the other hand, the mass error is significantly larger than the standard deviation, it indicates that the signal is likely sufficient but there may be a systematic bias in the mass measurement, due to the lack of a standard ion, or that the standard ion is too far away, in mass, from the sample ion. In this case, an additional standard ion may be introduced and measured. The additional standard ion(s) can be pooled with the previously measured standard ion(s) to form a new calibration that should reduce the mass bias vis-a-viz the standard deviation.

While standards can be introduced either before or after the sample measurement, it is highly desirable to have standards measured during the unknown measurement, to increase the sample throughput and minimize the impact of instrument drift on mass accuracy, among many other advantages. This can be achieved through premixing the sample with standards or online mixing in real time. While premixing is simpler to automate and corresponds to truly internal calibration with nearly no mass spectral drift, it suffers from potential interference between the sample and the standard, ion suppression between them, and extra required work if their concentrations or concentration ratios do not lend to an acceptable measurement statistic.

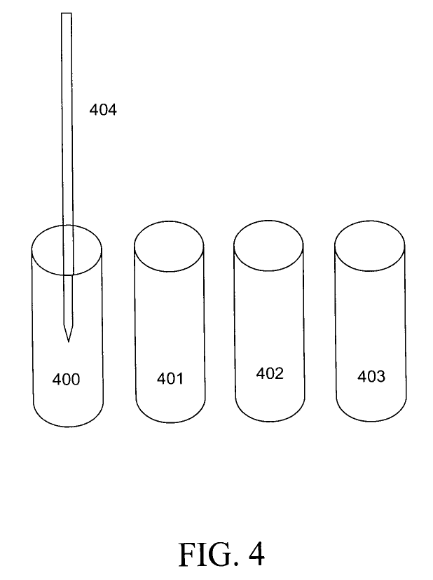

A few online mixing options will be disclosed here with references to FIGS. 4-6 in combination with FIGS. 2-3.

In FIG. 4 illustrates an autosampler, wherein 400 is a sample container, 401, 402, and 403 are standards containers, and 404 is an autosampler needle. The autosampler aspirates sample and selected standards sequentially, and then injects the mix of sample and standards simultaneously.

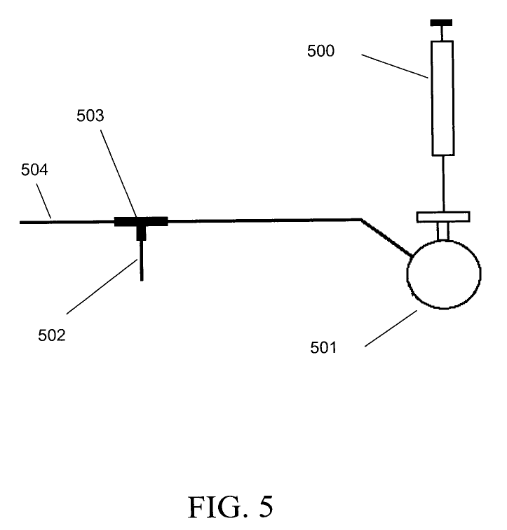

In FIG. 5, 500 is a syringe pump, 501 is an injection port/valve assembly, 502 is a tube from an liquid chromatograph (LC), 503 is a tee connector, and 504 is a tube to the MS. Some commercial autosamplers have more than one sample injector. One injector can be used for normal sample injection and another for standards infusion. Of course, a separated/independent injector can be used for standards infusion. The autosampler for standards infusion can pick selected standards, push the solution through injection port/valve assembly 501 and infuse it to the MS. Standards can be merged with LC effluent (during or post LC run), or just be infused by itself (LC effluent off).

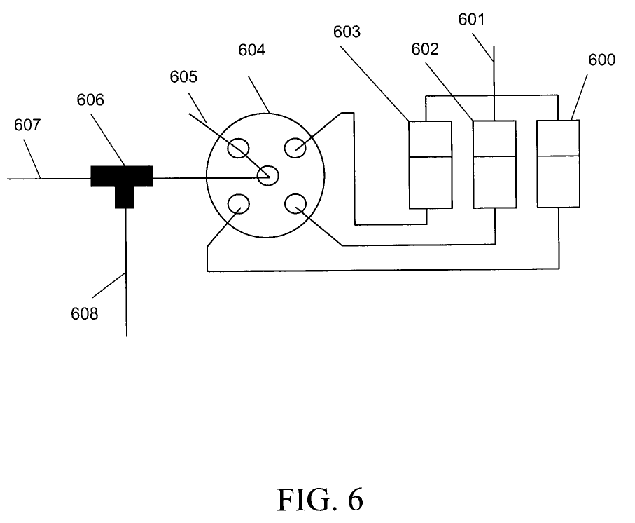

In FIGS. 6, 600, 602, and 603 are standards, 601 is a tube bring a pressurized gas, 604 is an N-To-1 selection valve; 605 is a blocked channel; 606 is a tee connector; 607 is a tube to the MS; and 608 is tube from the LC. Standards can be merged with LC effluent (during or post LC run), or just be infused by itself (LC effluent off).

Although the description above contains many specifics, these should not be construed as limiting the scope of the invention but as merely providing illustrations of some feasible embodiments of this invention. For example, the computer addressable holders for standards do not have to be in a sample tray. They can be sitting in a different tray or even built into the mass spectrometer, much like some MS tuning compounds currently in use, e.g., FPTBA used in commercial GC/MS systems.

For simplicity and clarity, the term m/z and mass have been used interchangeably throughout this document, a convention commonly used by those skilled in the art.

Thus the scope of the invention should be determined by the appended claims and their legal equivalents, rather than by the examples given. Although the present invention has been described with reference to the single embodiment shown in the drawings, it should be understood that the present invention can be embodied in many alternate forms of embodiments. In addition, any suitable size, shape or type of elements or materials could be used.

What is claimed is:

1. An automated mass spectral system for identifying a sample ion or compound, comprising:
at least one computer addressable holder for at least one of a standard and a sample;
at least one mass spectrometer configured to acquire one of continuum, profile, and raw mode mass spectral data;
a computer system including a first software component to control introduction of at least one of the sample and the standard, data acquisition, and data analysis;
a second software component for performing a mass spectral calibration involving at least m/z value, to report at least one of accurate mass, a list of possible elemental compositions, and a measurement statistic; and
a third software component capable of acting on reported result or the measurement statistic to change at least one of the introduction of at least one of the sample and the standard, data acquisition, data analysis, reported result, and measurement statistic.

2. The system of claim 1, where the mass spectrometer contains one of a quadrupole, ion trap, time of flight, magnetic sector, Fourier Transform, and dispersive mass analyzer.

3. The system of claim 1, wherein the mass spectrometer is operating at unit mass resolution.

4. The system of claim 1, wherein there is a computer addressable standard holder containing at least one standard capable of generating at least one ion of known elemental composition.

5. The system of claim 1, wherein there is a computer addressable sample holder containing at least one sample to be analyzed.

6. The system of claim 1, wherein the computer addressable holder contain both the standard and sample.

7. The system of claim 1, wherein at least one standard is placed in at least one of available positions in a multi-well plate.

8. The system of claim 7, where the multi-well plate is arranged in a 10×10, 8×12 or 12×8, or other higher or lower density formats.

9. The system of claim 1, wherein at least two standards are available for introduction into the mass spectrometer to cover an anticipated m/z range of samples.

10. The system of claim 9, wherein at least one standard is placed into one computer addressable standard holder to form an array of standards.

11. The system of claim 10, wherein each standard in the array of standards is presented to said mass spectrometer sequentially, one introduction at a time.

12. The system of claim 10, wherein at least a subset of the standards is combined online before introduction to said mass spectrometer.

13. The system of claim 12, wherein the online combining occurs in at least one of an injection needle, a mixing chamber, a flowing tube, liquid chromatography mobile phase, gas chromatography carrier gas, T-infusion, and a switchable multi-port valve.

14. The system of claim 9, wherein said at least two standards are pre-mixed, placed into one holder, and presented to the mass spectrometer through a single introduction.

15. The system of claim 1, wherein said third software component automatically selects and introduces at least one standard sample capable of generating at least one standard ion at close proximity to the estimated m/z value of the sample ion to be determined.

16. The system of claim 1, wherein the standard is capable of generating ions of known elemental compositions at predetermined m/z intervals within a given mass range.

17. The system of claim 1, wherein the m/z value of a standard is in close proximity to the estimated m/z value of the sample ion to be determined.

18. The system of claim 1, wherein an additional standard is introduced one of before, after, and during the sample introduction, to create a new mass spectral calibration with the additional standard included or previous standard excluded, so as to improve reported result or measurement statistic.

19. The system of claim 18, wherein the step of introducing said additional standard is repeated in an iterative fashion, based on a measurement statistic.

20. The system of claim 19, wherein the measurement statistic is one of mass accuracy, spectral accuracy, standard deviation, prediction interval, signal-to-noise, error, bias, residual, and other statistic reflecting the confidence of said measurement.

21. The system of claim 1, wherein the same sample or standard or both is introduced again and included in the data analysis to improve reported result or measurement statistic.

22. The system of claim 20, wherein the step of introducing is repeated in an iterative fashion, based on a measurement statistic.

23. The system of claim 1, wherein at least one experimental parameters, including but not limited to the flow rate, mass spectrometer scan rate, mass scan range, and mass spectral scan mode among full scan, zoom scan, and SIM scan is changed so as to improve reported result or measurement statistic.

24. The system of claim 22, wherein the step of parameter changing is repeated in an iterative fashion, based on a measurement statistic.

25. The system of claim 19, wherein the measurement statistic is one of mass accuracy, spectral accuracy, standard deviation, prediction interval, signal-to-noise, error, bias, residual, and other statistic reflecting the confidence of said measurement.

26. The system of claim 1, wherein a standard capable of generating multiple ions of known elemental compositions is utilized for calibrating in a given mass range.

27. The system of claim 1, wherein multiple standards capable of generating multiple ions of known elemental compositions are utilized for calibrating in a given mass range.

28. The system of claim 1, wherein a standard containing at least one ion of known elemental composition is selected and introduced one of before, during, and after the sample to adjust a previously available mass spectral calibration.

29. The system of claim 27, wherein said previously available calibration is adjusted through operations involving one of addition, subtraction, multiplication, and division.

30. The system of claim 1, wherein at least one standard is combined with said sample online for a single run measurement of both the standard and the sample.

31. The system of claim 29, wherein the online combining occurs in at least one of an injection needle, a mixing chamber, a flowing tube, liquid chromatography mobile phase, gas chromatography carrier gas, T-infusion, and a switch-able multi-port valve.

32. The system of claim 30, wherein the online combining occurs one of prior to, on, and post a chromatographic separation column.

33. The system of claim 1, further comprising a chromatographic separation column prior to said mass spectrometer.

34. The system of claim 32, wherein a standard is introduced towards the end of a chromatographic gradient run so as to acquire a mass spectrum of the standard with minimal mass spectral interference from the sample.

35. An automated mass spectral system for identifying a sample ion or compound, comprising:
a software component capable of acting on reported result or a measurement statistic of the mass spectral system to automatically change at least one of introduction of at least one of a sample and a standard, data acquisition, data analysis, reported result, and measurement statistic to automatically improve the accuracy of the mass spectral system.

36. A method for operating an automated mass spectral system to identify a sample ion or compound, comprising:
providing at least one computer addressable holder for at least one of a standard and a sample;
providing at least one mass spectrometer configured to acquire one of continuum, profile, and raw mode mass spectral data;
operating a computer system including a first software component to control introduction of at least one of the sample and the standard, data acquisition, and data analysis;
a second software component for performing a mass spectral calibration involving at least m/z value, to report at least one of accurate mass, a list of possible elemental compositions, and a measurement statistic; and
a third software component capable of acting on reported result or the measurement statistic to change at least one of the introduction of at least one of the sample and the standard, data acquisition, data analysis, reported result, and measurement statistic.

37. A method for automating a mass spectral system to identify a sample ion or compound, comprising:
utilizing a software component capable of acting on reported result or a measurement statistic of the mass spectral system to automatically change at least one of introduction of at least one of the sample and a standard, data acquisition, data analysis, reported result, and measurement statistic to automatically improve the accuracy of the mass spectral system.

38. A computer readable medium having computer readable program code therein for implementing the system of claim 1.

39. A computer readable medium having computer readable program code therein for implementing the system of claim 35.

40. A computer readable medium having computer readable program code therein for implementing the method of claim 36.

41. A computer readable medium having computer readable program code therein for implementing the method of claim 37.
